(19) United States
(12) Patent Application Publication
(10) Pub. No.: US 2010/0128879 A1
(43) Pub. Date: May 27, 2010

(54) FLEXIBLE MANAGEMENT OF SECURITY FOR MULTI-USER ENVIRONMENTS

(76) Inventors: Xukai Zou, Carmel, IN (US); Yuanshun Dai, Knoxville, TN (US)

Correspondence Address: KRIEG DEVAULT LLP, ONE INDIANA SQUARE, SUITE 2800, INDIANAPOLIS, IN, 46204-2079, US

(21) Appl. No.: 12/616,316

(22) Filed: Nov. 11, 2009

Related U.S. Application Data
(63) Continuation of application No. PCT/US2008/006027, filed on May 12, 2008.
(60) Provisional application No. 60/928,716, filed on May 11, 2007.

(51) Int. Cl. H04L 9/08

(52) U.S. Cl. 380/282

(57) ABSTRACT

One embodiment is a method including computing or storing an access control polynomial. Further embodiments include systems and computer readable media including an access control polynomial. Further embodiments, forms, objects, features, advantages, aspects, and benefits shall become apparent from the following description and drawings.

### BACKGROUND

Multiuser environments, such as trusted collaborative computing (“TCC”) environments, present a number of unmet challenges including those relating to secure group communication (SGC), secure dynamic conferencing (SDC), differential access control (DIF-AC), hierarchical access control (HAC), and other functionalities. Cryptography and key management have been investigated in various attempts to secure information; however, until now there has been no mechanism which is able to address the requirements for trusted or secure information transmission and data access in TCC or other multiuser environments.

### SUMMARY

One embodiment is a method including computing or storing an access control polynomial. Further embodiments include systems and computer readable media including an access control polynomial. Further embodiments, forms, objects, features, advantages, aspects, and benefits shall become apparent from the following description and drawings.

### BRIEF DESCRIPTION OF THE FIGURES

FIG. 1 is an exemplary CC environment.

FIG. 2 is an exemplary access control hierarchy.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and that all alterations and further modifications of the following embodiments and such further applications of the principles of the invention as would occur to one skilled in the art to which the invention relates are contemplated.

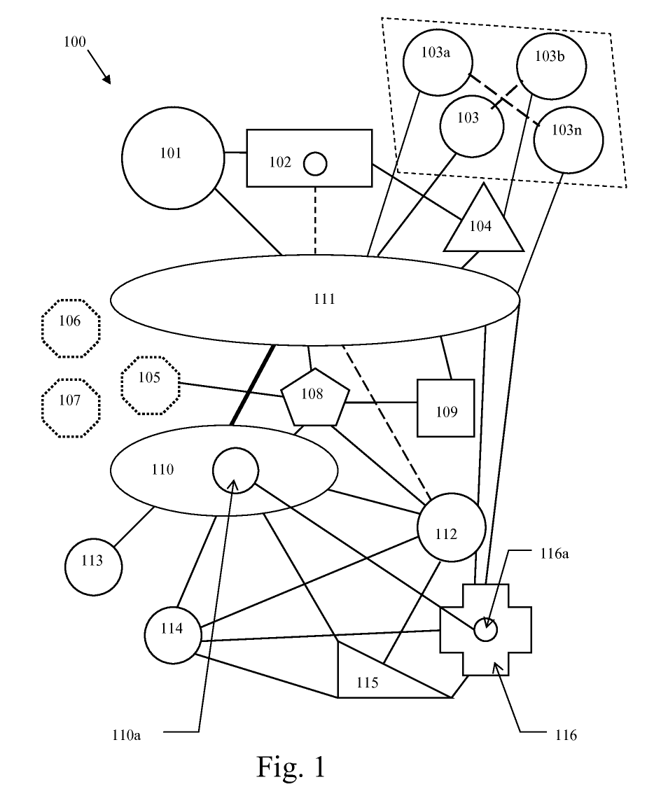

With reference to FIG. 1, there is illustrated an exemplary collaborative computing (“CC”) environment 100. Exemplary CC applications include, but are not limited to, multi-party military actions, tele-conferencing, video conferencing, tele-medicine, video medicine, interactive and collaborative decision making or conferencing, grid-computing, information distribution, and pay per view services. Further examples include enterprise management software and related applications, electronic mail systems and archives, key management systems, and others. Trust and/or security in such environment can eventually determine its success and popularity due to the desire for confidentiality, privacy and integrity of personal and/or shared information. Existing communication infrastructure such as the internet does not provide high assurance security for data transmission. Security patches and other computing/storage resources available to hackers result in more security vulnerabilities. Compared to two-party interaction models (such as the client-server service model), multiuser and CC environments may present additional challenges owing to the environments being group-oriented, involving a large number of entities and shared resources, being complex, dynamic, distributed, and heterogeneous and even possibly including hostile elements. Systems experience failures due to intrusions and attacks from hostile entities. In addition, there is the problem of insider threats, by which attacks are from malicious parties inside the organizations or members of CC groups. Consequently, establishing and maintaining trusted collaborative computing (TCC) environments is very difficult.

As illustrated in FIG. 1, exemplary CC environment 100 is complex and includes a diverse, heterogeneous group of users, resources, systems, communication links, hierarchies, access authorities, and may include internal and external threats. A central server 111 may distribute information to and receive information from a plurality of group members such as group members 101, 102, 103, 103a, 103b . . . 103n, 109, 112, and 116 via one or more communication links. Group members can also form sub-groups, such as the sub-group including members 103, 103a, 103b . . . 103n. Sub groups could also include greater or fewer numbers of members. The membership of groups and subgroups is dynamic and can increase or decrease. The functionalities of server 111 may also be distributed, for example, a second server 110 may also distribute information to and receive information from a plurality of group members such as group members 113, 114, 112, and 116 via one or more communication links. The nature of the distribution may be physical, virtual, or a combination thereof. In a exemplary embodiment, the central server is a server cluster, such as a blade or rack server system, with physical and software interconnections among cluster servers.

A variety of communication links are also illustrated in environment 100. Communication links may be electrical, magnetic, optical or combinations thereof. Communication links can also be wireless, such as the point-to-point wireless link interconnecting server 111 and group member 102, or point to multipoint wireless link between group members 106 and 107 and point to multipoint transceiver 105. One example of a point to point wireless link is a microwave transmission link. One example of a point to multipoint wireless link is a cell phone network such as one utilizing CDMA, TDMA, FDMA and other types of transmission protocols and systems. Another example is a WIFI network. A further example is a satellite network such as a direct broadcast satellite network. An additional example is a WIMAX network. There are a plurality of user types that may utilize such networks including cell phone, computer, PDA, video conferencing, audio conferencing, and other types of users. The communication links may include routers such as router 108, repeaters such as repeater 104, and other communication link features such as feature 115. Communication links may follow a variety of protocols such as IP, TCP, UDP, VoIP, SSL, and others, and may facilitate communication of a variety of types of information, such as packets, data, voice, picture, video and/or audio information. A variety of system and user resources, such as resource 110a of server 110, and resource 116a of user 116 may also be present in environment 110.

A exemplary embodiment may establish a trusted collaborative computing (TCC) environment to facilitate user collaboration in which entities work together and share resources and/or information. One security issue for such environments is that multiple participating entities should be able to communicate securely among one another via one or more communication channels. Techniques such as conventional IP multicast permit transmission of messages to a group of users; however, the open nature of conventional IP multicast makes it unable to provide strong confidentiality. Another security issue is related to resource sharing and data exchange. Access to shared resources/data may need to be precisely and accurately controlled; otherwise attackers and malicious users can access resources to which they are not entitled to access, abuse, tamper, and/or damage. Selective data sharing, at different granularity levels, along with access control is another security issue. It may be desirable for these classes of functions to be sufficiently flexible as to support various possible forms of interactive access relations between the parties and the resources in the system. Thus, security issues relevant for multi-user environments and TCC include hierarchical access control (HAC), secure group communication (SGC), secure dynamic conferencing (SDC), and differential access control (DIF-AC). Cryptography is a powerful tool to support all these and other security functions. Key management is a difficult issue in such context, and the generation, distribution, updating, and revocation of keys, such public keys, private keys, security tokens, seeds, or identifiers, in such environments, which may be large and dynamic, is a significant challenge.

Exemplary embodiments include an Access Control Polynomial (“ACP”). Some embodiments include an ACP through which secret information can be distributed so that only the intended recipients (i.e., their IDs are included as a term (x−ƒ(ID)) in the polynomial) can derive that secret information. Some embodiments utilize an ACP to support security in highly dynamic environments where, for example, users join/leave and there are addition/deletion of resources/data/messages, addition and removal of user/resource relations, random user/data structures/formats according to fine-tuned granularity (e.g., in the levels of users, user groups, data sets, data records, record fields), and/or anonymity (i.e., group membership and size can be hidden from both outsiders and insiders). Some embodiments utilize an ACP to support a plurality of different security functions and provide integration of various application systems. Some embodiments provide resistance or immunity to various attacks, including external hackers and internal malicious members, and even collusion between internal and external attackers.

An ACP can be described with mathematical rigor. For this discussion the following notation will be used (though different notation might also be applied in other contexts):

A(x) The access control polynomial in the form of

$$A ( x ) = {\prod }_{i ∈ ψ} ( x - f ( {SID}_{i} , z ) )$$

F_{q}: The finite field
ƒ: A public cryptographic hash function. It is used in the form of ƒ(x,y), i.e. ƒ(x∥y)
GIDᵢ: Secret Group Identification, a positive integer
P(x) The public polynomial sent to users for key distribution, P(x)=A(x)+K
q: A large prime, as a predefined system parameter
SIDᵢ: Personal Permanent Portable Secret, a positive integer
Uᵢ A group member in a certain group
vⱼ A certain vertex in the hierarchy
z A random integer which is changed and made public every time.
% Mod operation

Let us consider exemplary environments having the following characteristics: (1) q is a large prime from which a finite field F_{q} is formed, preferably a large prime number, such as 512 bits, 1024 bits, or an even greater number of bits, (2) ƒ: {0,1}*→{0,1}^{q} is a cryptographic hash function, and (3) there is a trusted system component, resource, or computer, such as, for example, a server. Every valid user, say Uᵢ, in the system is assigned a Personal Permanent Portable Secret, called P3-Secret and denoted as SIDᵢ (a random positive integer less than q). This secret is only known to the user and the central server. Since users are generally required to register to the system, the assignment of an SID to a user can be performed during the registration procedure, for example, by using a two-party security mechanism.

An exemplary ACP is a polynomial over a finite field F_{q} [x] and defined as follows.

$$A ( x ) = {\prod }_{i ∈ ψ} ( x - f ( {SID}_{i} , z ) ) \qquad Eq . ( 1 )$$

where ψ denotes the user group under consideration, SIDᵢ are group members' P3-Secrets assigned to the members in the group ψ, and z is a random integer from Fₚ and is made public. In addition, z is changed every time A(x) is computed. A(x) is equated to 0 when x is substituted with ƒ(SIDᵢ,z) by a valid user with SIDᵢ in the group ψ; otherwise, A(x) is a random value if other numbers or invalid users' P3-Secrets are used in the substitution.

In order to broadcast a secret value such as K to the users in group ψ, the following polynomial can be computed (for example, by a trusted server):

P(x)=A(x)+K Eq. (2)

Then, (z,P(x)) is distributed or publicized (for example, broadcast) and K is hidden, mixed with A(x). From this public information, any group member Uᵢ with SIDᵢ can obtain the secret value, K, by:

K=P(ƒ(SIDᵢ,z)) Eq. (3)

Utilizing an ACP, key management for a large range of security functions and applications can be accomplished. For example, ACP key management can be accomplished for SGC, SDC, DIF-AC and/or HAC.

SGC refers to a setting in which a group of members can communicate (or share the information) among themselves, in a way that outsiders are unable to understand the communication (or the information) even when they are able to intercept the communication (or the information). The confidentiality of the SGC communication is provided by encrypting the communication with a group key which is distributed to only the group members.

In one SGC embodiment a trusted server computes A(x) by Eq. (1) (Step 1), P(x) by Eq. (2), and then multicasts (z, P(x)) (Step 2). Every user in the group can then compute the key via Eq. (3) (Step 3). After all group members obtain the same key, they can conduct group communication securely.

Let us consider group dynamics. Users can join, leave or be revoked from the system. From the construction of A(x), it can be seen that regardless of whether we deal with single join, single leave, multiple joins, multiple leaves, or multiple joins and leaves simultaneously, dynamics can be implemented with great elegance and easily: the above steps 1), 2), and 3) are followed but in the formation of A(x), just the joining users' SIDs (in fact, ƒ(SIDᵢ,z)) are included and the leaving users' SIDs are excluded. Note that z and K in these steps are new random numbers. Once the key is changed, the encryption with the new key will prevent the leaving (or joining) users from accessing the future (or the past) information.

SDC refers to a scenario where any subset, for example a random subset, of the given user population can form a secure communication (sub)group. As it is evident, SDC is closely related to SGC: as an extension of SGC or equivalently, SGC as a specific case of it. Suppose the size of the universe under consideration is n, there will be 2ⁿ−n−1 possible conferences. Pre-generating all these 2ⁿ−n−1 conferences might not be preferred because many conferences may never need to be activated. In addition, conferences may not occur at the same time.

A preferred ACP embodiment includes an on-the-fly feature, which means that whenever there is a need to distribute a secret to a specific user group, just the above steps 1), 2), and 3) are executed. This feature is useful for supporting SDC. Whenever there will be a conference of any subset of users, the server just performs the three steps where A(x) includes SIDs of the conference members. If a user participates in multiple conferences at the same time, the user's SID can be included in multiple corresponding A(x)'s and the user then can get the keys for all these conferences. Whenever users want to join or leave a conference, the above three steps are executed with A(x) just including the intended users. Thus, group dynamics can be efficiently processed in SDC.

Access control is used for checking whether a user has the right to access a certain resource or information and for granting or denying access as required. Access control can be a fundamental security issue for many computing systems in which users and resources are involved. In DIF-AC, a user can (and only can) access certain resources and a resource can (and only can) be accessed by certain users (i.e., many-to-many relation, determined by, for example, subscription and payment). Exemplary applications requiring DIF-AC include, but are not limited to, e-newspapers, pay-per-view broadcast TV, multiple streaming services and/or secret or confidential communications.

Like the above SDC scheme, every resource Rₖ is associated with a dynamic key Kₖ, and the users who can access Rₖ are treated as a conference. The server computes Aₖ(x) and Pₖ(x), and publicizes (z,Pₖ (X)). Thus, the user, who can access Rₖ, can derive key Kₖ and is granted access to resource Rₖ. If a user can access multiple resources, the user's SIDᵢ will be included in the Aₖ(x)'s of all these resources. Thus, the user can access all these resources. Similarly, dynamics can be implemented by inclusion and exclusion of users' SIDs in the formation of new Aₖ(x)'s.

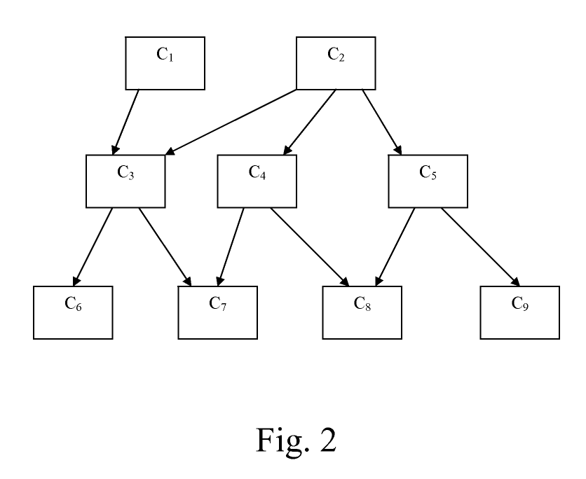

HAC occurs when resources (and users) have some hierarchical relation: resources are assigned levels and a user who has the access right to a resource at one level is automatically granted access to the resources which are the resource's children or descendants at lower levels. However the reverse is not allowed. The most generic format of HAC can be represented as a Directed Acyclic Group (DAG) (as illustrated in FIG. 2). A node in the hierarchy can represent a user, a resource, a set of users, a set of resources, or both users and resources.

For every node/class Cₖ in the hierarchy, the server selects a unique CIDₖ and distributes securely CIDₖ to Cₖ's users {U₁, U₂, . . . , Uₙ} using the same scheme as that in SGC, i.e., the server computes P(x)=(x−ƒ(SID₁,z))·(x−ƒ(SID₂,z)) . . . (x−ƒ(SIDₙ,z))+CIDₖ and multicasts (z, P(x)) to Cₖ's users. The server also selects a dynamic key Kₖ for every Cₖ. Now, the server constructs Aₖ(x) using this node's CIDₖ as well as CIDs of all its ancestors:

$${A}_{k} ( x ) = ( x - f ( {CID}_{k} , z ) ) {\prod }_{i ∈ ψ} ( x - f ( {CID}_{i} , z ) ) \qquad Eq . ( 4 )$$

where the first term is Cₖ itself and the next terms are associated with all the ancestors Cᵢ of Cₖ (ψ is the set of ancestors of Cₖ). Then, the server constructs Pₖ(x)=Aₖ(x)+Kₖ and publicizes (z,Pₖ(x)). The node Cₖ (i.e., the users in Cₖ) can compute the key Kₖ as Kₖ=Pₖ(ƒ(CIDₖ,z)). Furthermore, any ancestor (i.e., the users in) Cᵢ of Cₖ can also derive the key Kₖ as Kₖ=Pₖ(ƒ(CIDᵢ,z)). However, Cₖ cannot reversely get Cᵢ's key. Thus, the hierarchical access control is correctly and securely enforced.

In this ACP-based HAC scheme, the key derivation by the node's ancestors is performed in the identical way as the key computation by a node. Moreover, nodes do not need to know the exact hierarchy. The nodes that are ancestors of a node will obtain the correct key of the node when substituting their CID into P(x) but others will not.

There are two level dynamics in HAC: node level and user level. The node level dynamics include adding a node, deleting a node, moving a node from one place to another, adding one link between two nodes, and deleting a link between two nodes. User level dynamics include addition and deletion of a user from a node group and movement of a user from one node group to another. Based on ACP, both level dynamics can be accomplished efficiently.

Let us consider the operation of deleting a node, since revocation/deletion is generally more difficult to deal with than joining/addition. There are two cases to consider: a leaf node and an internal node. If the deleted node is a leaf node, nothing needs to be done other than discarding the information/values related to this node. If the deleted node is an internal node, a technique should be used to relocate the node's children, for example, a relocation policy or algorithm. However, the particular technique used for such purpose does not matter here. Since the deleted node knew the keys of all its descendants, these keys need to be changed, which is easy. For each of the descendant nodes of the deleted node, the server computes A(x) which includes the CIDs of all new ancestors of the node but excludes the CID of the deleted node and multicasts (z, P(x)=A(x)+K).

Consider the second level dynamics. For example, if one member (with SIDₗ) leaves group Cₖ and attends another group Cⱼ, the following two steps complete the update.
1) The new node CID in node Cₖ is updated by the above polynomial excluding the term (x−ƒ(SIDₗ,z′)) (Note: a new z′ is used).
2) The new node CID of the group Cⱼ is updated with the above polynomial including the term (x−ƒ(SIDₗ,z″)) (Note: a new z″ is used).

An ACP embodiment can address the HAC problem in the same manner and the same efficiency of SGC/SDC. Exemplary applications involving HAC include government or private organization computer systems, digital libraries, medical information systems, systems storing proprietary information, and systems including other confidential or limited access information.

We now analyze the security and performance of the above ACP embodiment. By the security analysis, we show that the proposed ACP mechanism is very robust and secure not only against outside attackers which do not know the shared key but also against the insiders which know the shared key. By the performance analysis, we show that the ACP mechanism is very efficient.

We discuss the security of ACP embodiments in terms of external attackers, internal attackers, and collusion of attackers. First, let us consider the key space and the guessing or brute-force attack. K is randomly and uniformly selected from 0 to q−1. In addition, K can be coincident with any of SIDᵢ and vᵢ=ƒ(SIDᵢ,z), for i=1, . . . , n since it will not affect the correctness of the ACP mechanism. Thus, the introduction of the access polynomial (no matter how high its degree is) will not reduce the size of the key space. As for the brute-force attack, an external attacker can either guess K directly or guess one of vᵢ and then compute K, or guess one of SIDᵢ and compute vᵢ and then K. The probability that a random guess hits K is 1/q whereas it is n/q to hit any of vᵢ and another n/q to hit any of SIDᵢ. Thus, the overall probability for a random trial to success is (2n+1)/q. This means that the access control polynomial increases the success chance of the brute-force attack by a factor of 2n. The more users are included in the polynomial, the higher the probability of success by the brute-force attack. However, due to the efficiency of the ACP mechanism (as discussed below), q can be selected to be very large, thus, making the brute-force attack inapplicable. Next, let us consider the attacks in which an external attacker tries to obtain the group key K or group users' SIDs from P(x). The K is hidden in the publicized constant term of P(x), i.e. c₀=(K+V)% q where V=v₁·v₂ . . . v and vᵢ=ƒ(SIDᵢ,z), for i=1, . . . , n. Since there are many other pairs of K′ and V′ such that c₀=K′+V′, the attacker cannot uniquely determine K from c₀. As for trying to determine all of K, v₁, v₂, . . . , vₙ from (the coefficients of) P(x) at the same time, the attacker will fail because only n equations can be formed for n+1 unknown K, v₁, v₂, . . . , vₙ. As for trying to determine SIDᵢ, the only relevant value is vᵢ=ƒ(SID z) which is difficult to be obtained from P(x) as discussed above. Even if the attacker were able to determine vᵢ=ƒ(SIDᵢ,z) somehow, the attacker still would not be able to get SIDᵢ since this would require inversion of the cryptographic hash function ƒ. Finally, multiple external attackers may collude to determine K or SIDᵢ, but their collusion provides no more information than the information that would be obtained by a single attacker; collusion is thus useless. ACP embodiments are resistant to external attacks.

We now consider the case of internal malicious users. Obviously, an internal user can obtain K from its own SIDᵢ. Thus the purpose of an internal malicious user is to obtain the SIDs of some other users so that he can get the secret information, reserved to other users, to which he is not authorized to access. He can obtain the exact polynomial A(x) as A(x)=P(x)-K and then set A(x)=0 to determine the roots of A(x). He may find vᵢ=ƒ(SIDᵢ,z), however, it is computationally infeasible to get SIDᵢ from vᵢ=ƒ(SIDᵢ,z) due to the one-way feature of the cryptographic hash function ƒ. Getting vᵢ of the other user does not therefore help the attacker. First, vᵢ will result in K to be disclosed, but this does not help at all because he had been allowed to get K from his own SID. Additionally, this vᵢ=ƒ(SIDᵢ,z) can be only used for getting this K and cannot help in determining any other keys from other P(x)'s because z is updated every time and two vᵢ s in two P(x)'s will be different even though SIDᵢ is the same. As a result, the internal malicious user cannot violate the security of the ACP embodiment. Furthermore, it is useless for multiple internal users to collude because their collusion cannot help to make the inverse of the cryptographic hash function easier, thus, making impossible to get SIDᵢ from vᵢ. The collusion of internal malicious users and external attackers is also useless in getting other users' SID (Note: the collusion here does not include the case of an internal user giving his SID or the key to an outsider so that the outsider can access the information. If this case is considered as a collusion, then it is inherent in all cryptosystems and there is no technological solution to it).

The attackers may hope to glean multiple P(x)'s and try to get useful information from them; however, this attempt would also be useless due to the changing P(x′)s. There are different forms of collusions in the hierarchy such as two siblings trying to figure out their parent's key, a node and its nephew trying to figure out its parent key. However, these cases of attacks can be reduced to the collusion of external attackers, or internal malicious members or internal/external users depending on whether (and how many) their SIDs are included in P(x). As discussed above, a preferred ACP embodiment is able to defend against any such collusion.

The storage complexity (at both user end and server end), computation complexity (at both the user end and server end), and communication complexity can be analyzed. The user-end storage cost is O(1) since a user just needs to store its P3-Secret SID (plus its node CID if in the HAC hierarchy). The server storage cost is O(n+m) since the server needs to store all n users' SIDs (plus m nodes IDs if in the HAC hierarchy). Suppose there are n terms involved in the generation of P(x). There are two parts to consider. The first part is related to computing ƒ(SID,z). The running time of the cryptographic hash function totally depends on itself but is independent from the number of terms n. Suppose its running time is O(B), then computing n ƒ(SID,z) has a cost in O(nB). The other part is to multiply n terms (x−v)'s. The main operations are multiplication (with modulo) and addition (with modulo). There are in total O(n²) of such operations. The computation complexity for multiplying n terms (x−v)'s is in O(n²). Thus, the total computation complexity for generating P(x) is in O(nB+n²)=O(n²). This polynomial computation complexity is efficient for the server. We now consider the computation complexity for computing the key from a polynomial P(x) of degree n when replacing x with the computed value v=ƒ(SID,z). The main operations here are: 1) the computation of v, v²% q, . . . , vⁿ% q which requires n multiplications (with modulo); 2) the multiplication of each of these values with its corresponding coefficient, which requires another n multiplications; and 3) the addition of the results, which requires n additions. In total, the complexity of computing the key from P(x) is in O(n). With respect to the communication complexity, broadcasting P(x)=aₙxⁿ+aₙ₋₁xⁿ⁻¹+ . . . +a₁x+a₀ requires to broadcast the coefficients aₙ, aₙ₋₁, . . . , aₗ, a₀. Thus, the communication complexity is in O(n). These complexities are summarized in Table 1 below. Note: key derivation is similar to key computation.

TABLE 1
Complexities of the ACP based key management

| Terms | Complexity |
|---|---|
| User end storage | O(1) |
| Server end storage | O(n + m) |
| Key computation | O(n) |
| Key derivation | O(n) |
| P(x) generation | O(n²) |
| Communication | O(n) |

From the above complexity analysis, it is clear that all complexities are proportional to n, the number of current users in the group. If n is large but just a single user or few users join or leave the group, O(n) or O(n²) is not efficient. There are several ways to improve its efficiency. 1) As for join, the server can just generate a new key and encrypt the new key with the old group key and send it to the group. The server also encrypts the new key with the SID of the joining user and sends it to the joining user. 2) In order to improve the efficiency of computing P(x), we can store and save A(x) in advance. If one or a few users U₁, . . . , Uₖ leave, we can get the new A(x) by directly dividing A(x) by (x-ƒ(SID₁,z)) . . . (x-ƒ(SIDₖ,z)), thus, the complexity for P(x) generation will reduce to O(n). 3). For improving the efficiency of key computation and derivation, we can divide the n users into k=n/l separate groups of l users each. The server forms k polynomials of degree l each. Every user can obtain the key by replacing its own SID to its corresponding polynomial. Thus, the complexity for key computation/derivation will reduce to O(l). Next, we describe a mechanism which can improve the efficiency greatly: tree based multiple level and hierarchical grouping.

Suppose n is the number of all users and m is the size of a small group which can be managed easily and efficiently, for example, m=16. Then every m users form a first level group, so a total n/m of such groups G_{1,1}, . . . , G_{1,n/m} are formed. Next, every m first level groups form a second level group, thus, a total n/m² of such groups G_{2,l}, . . . , G_{2,n/m}_{²} are formed. By continuing with this strategy, finally a highest level group is formed G_{log}_{ₘ}_{ⁿ}ₗ. All these groups can be treated as nodes in an m-ary tree of height logₘⁿ. Every group G_{i,j} is associated with a group key K_{i,j} and the K_{log}_{ₘ}_{ⁿ}_{,l} will be the group key for all users. The group keys are distributed to their members using an ACP embodiment. For example, K_{1,j} is distributed to group G_{1,j} by forming the ACP polynomial using the SIDs of the users in its group, i.e. P_{1,j}(x)=Π(x−ƒ(SIDᵢ,z))+K_{1,j} where UᵢεG_{1,j}. The second level key K_{2,j} is distributed to all users belonging to group G_{2,j} by forming the ACP polynomial using the group keys of its first level groups, i.e. P_{2,j}(x)=A_{2,j}(x)+K_{2,j}=Π(x−ƒ(K_{1,i},z))+K_{2,j} where G_{1,i}εG_{2,j}. Finally, the highest level key will be distributed by forming P_{log}_{ₘ}_{ⁿ}_{,1}=Π(x−ƒ(K_{log}_{ₘ}_{ⁿ}_{-1,i},z))+K_{log}_{ₘ}_{ⁿ}_{,1}.

Let us consider the case of a single user leaving his group. The group keys along the path from the leaf group of the leaving user to the root group need to be changed. Total logₘⁿ polynomials of degree m need to be computed and broadcast. Thus, the total polynomial generation time will be O(m² logₘⁿ), the communication complexity is O(m logₘⁿ), and the key computation and derivation are also in O(m logₘⁿ). For example, suppose m=16, n=2⁶⁴, then the polynomial generation time, key computation time, and communication complexity are in 2048 units of time, 256 units of times, and 256 units of numbers for transmission.

An ACP embodiment can preferably hide the group membership and size from outsiders (and even insiders) preferably without member serialization. Without a preferred ACP embodiment, in a multicast to a group of users, the information identifying users would need to be included in the multicast packet, and the users would need to be ordered according to some strategy (referred to as serialization), so that each user knows which portion of the protected key material belongs to him and is thus able to extract the group key from that portion. This would not only result in more computation work (e.g., a user needs to search for his portion) and need synchronization due to the serialization but also unintentionally result in disclosures concerning the group membership information. Keeping group membership information private to outsiders may be important in some applications. Furthermore, it may be desirable or even necessary to hide the group membership from the group users themselves in some applications, for example, a user knows that he is in the group but does not have knowledge about which are the other members of the group. It may also be desirable to hide the size of the group.

A preferred ACP embodiment provides an efficient and elegant solution to address one or more (even all) of the aforementioned features wherein a polynomial hides the group users and does not need to sort the group members. A valid user does not need to know (in fact, he cannot know if the server does not want to tell him) the membership and the order of members but he can get the group key easily by just plugging its SID into the polynomial. A preferred ACP embodiment can be easily extended for the purpose of hiding group size by simply including some random pseudo terms in the polynomial such as:

$$A ( x ) = {\prod }_{i ∈ ψ} ( x - f ( {SID}_{i} , z ) ) {\prod }_{j = 1 … d} ( x - {VID}_{j} )$$

where VID₁, . . . , VID_{d} are random numbers in F_{q}, called pseudo terms, and d is a random positive integer. As a result, the degree of P(x) does not indicate the number of members involved in the computation. These pseudo terms make P(x) even more randomized.

Adding random terms will increase the degree of P(x), thus, impacting the efficiency of the ACP embodiment. However, using the extended tree-based key distribution mechanism discussed above, the impact on efficiency is reduced. Decisions whether to add or how many random terms to be added is a trade-off between security and efficiency, and are preferably determined based on the requirements of concrete applications.

A preferred ACP embodiment is powerful enough to adapt to random forms of interactive/access relations among users and/or resources. These relations include, but are not limited to, equivalent users/resources, one-to-many, many-to-one, many-to-many, hierarchy, multiple levels, etc. For example, if a node Cᵢ's access permission needs to be transferred to a random other node Cⱼ, regardless of the relation and distance between the two nodes in the hierarchy, just include Cⱼ's CID_{P} in the construction of Aᵢ(x).

An additional exemplary embodiment includes software stored in a computer accessible medium including an ACP which is: adaptable to different kinds of key management and different kinds of access control relation schemes; able to enforce access control and secure group communication at a plurality of scales and granularities; able to integrate heterogeneous data sources and systems; able to protect against external attacks, internal attacks, and combined external and internal attacks; supports dynamic environments including the adding and/or revocation of members and/or resources; does not require member serialization or synchronization and does not disclose membership; able to hide the identities of members of the group and the group size; and able to implement flexible key management on the fly. A further exemplary embodiment is a system which utilizes such software. Another exemplary embodiment is a method which utilizes the functionalities of such software.

One exemplary embodiment is a method including computing or storing in a computer accessible medium a first polynomial which is a function of a set of numbers each associated with a member of a group to be provided a cryptographic information, determining a second polynomial which is a function of the first polynomial and an information to be privately shared with the group, and using at least one of the first polynomial and the second polynomial in providing communication between or among two or more members of the group. A further exemplary embodiment includes the providing communication between or among two or more members of the group includes providing at least one of a trusted collaborative computing environment, a secure dynamic conferencing environment, a differential access control environment, and a hierarchical access control environment. In a further exemplary embodiment the first polynomial is a function of a public random number. In a further exemplary embodiment the first polynomial includes a term which is zero when evaluated with one of the set of numbers each associated with a member of a group to be provided a cryptographic key. In a further exemplary embodiment the first polynomial is described by the formula:

$$A ( x ) = {\prod }_{i ∈ ψ} ( x - f ( {SID}_{i} , z ) )$$

where A(x) denotes the first polynomial, i denotes a member of the group, ψ denotes the group, SIDᵢ denotes the numbers each associated with a member of the group, and z denotes a random number. In a further exemplary embodiment the cryptographic information is a cryptographic key. A further exemplary embodiment includes distributing the second polynomial to the group. A further exemplary embodiment includes at least one member of the group receiving the second polynomial. A further exemplary embodiment includes obtaining the cryptographic information from a distributed polynomial. A further exemplary embodiment the includes obtaining the cryptographic information by calculating

K=P(ƒ(SIDᵢ,z))

where K denotes the cryptographic information, P denotes second polynomial, i denotes a member of the group, SIDᵢ denotes the numbers each associated with a member of the group, and z denotes a random number. A further exemplary embodiment includes communicating among two or more members of the group and utilizing the cryptographic information to secure the communication. A further exemplary embodiment the includes defining a subset of the group, communicating among the subset, and utilizing the cryptographic information to allow access to the communication only to the subset. A further exemplary embodiment includes conditionally granting access to a resource to one or more members of the group. In a further exemplary embodiment the first polynomial is defined in a finite field which is formed from a prime number. In a further exemplary embodiment the resource is one of a broadcast of information and a stream of digital information. A further exemplary embodiment includes adding a member to the group. A further exemplary embodiment includes storing computing or storing a third polynomial which is a function of a new group including one or more added members. A further exemplary embodiment includes removing a member from the group. In a further exemplary embodiment the removing a member from the group includes computing a third polynomial which is a function of a new group removing one or more members. In a further exemplary embodiment the providing communication between or among two or more members of the group includes providing secure group communication, secure dynamic conferencing, differential access control, and hierarchical access control. In a further exemplary embodiment the communication between or among two or more members includes communication via at least one of a packet switched communication link, a wireless communication link, a WIFI communication link, a WIMAX communication link, a communication link utilizing a IP, TCP, UDP, VOIP or SSL, and a communication link utilizing CDMA, TDMA, or FDMA. In a further exemplary embodiment the removing a member from the group includes determining a fourth polynomial which is a function of the third polynomial.

One exemplary embodiment is a system including at least one computer accessible memory configured to store an access control polynomial which is a function of a set of integers personal to and secret to members of a group, a processor operable to process the access control polynomial and information to be shared with at least one member of the group to generate a public polynomial, and an interface to a communication link operable to output the information to be shared with at least one member of the group to the communication link. In a further exemplary embodiment the computer accessible memory is configured to store instructions for distributing the public polynomial. In a further exemplary embodiment the information to be shared with at least one member of the group information is a key. In a further exemplary embodiment the computer accessible memory further includes instructions for distributing the key to the group members. In a further exemplary embodiment the computer accessible memory further includes instructions for providing SGC. In a further exemplary embodiment the computer accessible memory further includes instructions for providing SDC. In a further exemplary embodiment the computer accessible memory further includes instructions for providing DIF-AC. In a further exemplary embodiment the computer accessible memory further includes instructions for providing HAC. In a further exemplary embodiment the computer accessible memory further includes instructions for providing SGC, SDC, DIF-AC, and HAC.

While multiple embodiments, forms, objects, features, advantages, aspects, and benefits have been illustrated and described in detail in the drawings and foregoing description, the same are to be considered as illustrative and not restrictive in character, it being understood that only exemplary embodiments have been shown and described and that all changes and modifications that come within the spirit of the inventions shall be protected. It should be understood that while the use of words such as exemplary, preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. It is intended that words such as “a,” “an,” “at least one,” or “at least one portion” are not limited to only one item unless specifically stated to the contrary. When the language “at least a portion” and/or “a portion” is used the item can include a portion and/or the entire item unless specifically stated to the contrary.

1-31. (canceled)

32. A method of providing cryptographic key information from a computer to a plurality of users, the method comprising:
operating the computer to compute an access control polynomial, the access control polynomial being a function of a first random number and a first plurality of user identifications, each of the first plurality of user identifications identifying a respective one of a first plurality of users;
operating the computer to compute a public polynomial, the public polynomial being a function of the access control polynomial and the cryptographic key information; and
operating the computer to provide the public polynomial and the first random number to the plurality of users, the cryptographic key information being accessible to each of the plurality of users based upon the second polynomial, the first random number, and each user's respective user identification.

33. A method according to claim 32 wherein the access control polynomial is computed according to:
$$A ( x ) = {\prod }_{i ∈ ψ} ( x - f ( {SID}_{i} , z ) )$$
wherein A(x) is the access control polynomial, i is a user of the plurality of users, ψ is the plurality of users, x is a variable, ƒ is a cryptographic hash function, SIDᵢ is the identification associated with each user, and z is the first random number.

34. A method according to claim 33 wherein the public polynomial is computed according to:
P(x)=A(x)+K
wherein P(x) is the public polynomial, and K is the cryptographic key information.

35. A method according to claim 34 wherein the cryptographic key information is accessible to each of the plurality of users by computing K=P(ƒ(SIDᵢ,z)).

36. A method according to claim 1 wherein access control polynomial is defined in a finite field which is formed from a prime number.

37. A method according to claim 32 further comprising:
operating the computer to compute a second access control polynomial, the second access control polynomial being a function of a second random number and a second plurality of user identifications, the second plurality of user identifications excluding one or more user identifications of the first plurality of user identifications;
operating the computer to compute a second public polynomial, the second polynomial being a function of the second access control polynomial and a second cryptographic key information; and
operating the computer to provide the second public polynomial and the second random number to the second plurality of users, the cryptographic key information being accessible to each of the second plurality of users based upon the second polynomial, the second random number, and each user's respective user identification, the second cryptographic key information being inaccessible by users having a user identification excluded from the second plurality of user identifications.

38. A method according to claim 32 further comprising:
operating the computer to compute a second access control polynomial, the second access control polynomial being a function of a second random number and a second plurality of user identifications, the second plurality of user identifications adding one or more user identifications relative to the first plurality of user identifications;
operating the computer to compute a second public polynomial, the second polynomial being a function of the second access control polynomial and a second cryptographic key information; and
operating the computer to provide the second public polynomial and the second random number to the second plurality of users, the second cryptographic key information being accessible to each of the second plurality of users based upon the second polynomial, the second random number, and each user's respective user identification.

39. A method according to claim 32 further comprising communicating among two or more members of the group and utilizing the cryptographic key information to secure the communication.

40. A method a according to claim 39 wherein the communicating includes transmitting information via a packet switched communication link.

41. A method a according to claim 39 wherein the communicating includes transmitting information via a wireless communication link.

42. A method according to claim 32 wherein the access control polynomial is computed according to:
$$A ( x ) = {\prod }_{i ∈ ψ} ( x - f ( {SID}_{i} , z ) )$$
wherein A(x) is the access control polynomial, i is a user of the plurality of users, ψ is the plurality of users, x is a variable, ƒ is a cryptographic hash function, SIDᵢ is the identification associated with each user, and z is the first random number and the public polynomial is computed according to:
P(x)=A(x)+K
wherein P(x) is the public polynomial, and K is the cryptographic key information; the method further comprising one or more of the users accessing the cryptographic key information by computing K=P(ƒ(SIDᵢ,z)).

43. A method according to claim 32 further comprising:
operating the computer to compute a second access control polynomial, the second access control polynomial being a function of a second random number and a second plurality of user identifications, the second plurality of user identifications excluding one or more user identifications of the first plurality of user identifications and adding one or more user identifications relative to the first plurality of user identifications;
operating the computer to compute a second public polynomial, the second polynomial being a function of the second access control polynomial and a second cryptographic key information; and
operating the computer to provide the second public polynomial and the second random number to the second plurality of users, the cryptographic key information being accessible to each of the second plurality of users based upon the second polynomial, the second random number, and each user's respective user identification, the second cryptographic key information being inaccessible by users having a user identification excluded from the second plurality of user identifications.

44. A method according to claim 32 wherein the cryptographic key information comprises a cryptographic key seed or a cryptographic key.

45. A method according to claim 35 further comprising operating the computer to calculate a new access control polynomial by dividing the access control polynomial by a term including one or more of the user identifications.

46. A method according to claim 33 wherein the access control polynomial is computed using one or more random terms effective to hide the number of user identifications included in the access control polynomial.

47. A computer readable medium configured to store program instructions executable by a computer to perform the following acts:
computing a first polynomial, the first polynomial being a function of a first random number and a first plurality of user identifications;
computing a second polynomial, the second polynomial being a function of the first polynomial and cryptographic key information; and
outputting the second polynomial and the first random number, the cryptographic key information being computable based upon the second polynomial, the first random number, and any one of the user identifications.

48. A computer readable medium according to claim 47 wherein the first polynomial is computed as a product of functions applied to the user identifications.

49. A computer readable medium according to claim 47 wherein the functions are cryptographic hash functions.

50. A computer readable medium according to claim 47 wherein the first polynomial is computed according to:
$$A ( x ) = {\prod }_{i ∈ ψ} ( x - f ( {SID}_{i} , z ) )$$
wherein A(x) is the first polynomial, i is a user of the plurality of users, ψ is the plurality of users, x is a variable, ƒ is a cryptographic hash function, SIDᵢ is the identification associated with each user, and z is the first random number.
